(19) United States
(12) Patent Application Publication
(10) Pub. No.: US 2025/0180151 A1
(43) Pub. Date: Jun. 5, 2025

(54) A CRAWLER-TYPE PIPELINE DETECTOR

(71) Applicant: BONBON-X LIMITED, HONG KONG (HK)

(72) Inventor: Man Chun WONG, HONG KONG (HK)

(21) Appl. No.: 18/561,211

(22) PCT Filed: Sep. 25, 2023
(86) PCT No.: PCT/IB2023/059430

§ 371 Date: Jan. 15, 2025

(30) Foreign Application Priority Data
Oct. 18, 2022 (CN) 202211274677.5

(51) Int. Cl. F16L 55/30; B62D 55/116; B62D 55/12

(52) U.S. Cl. CPC F16L 55/30; B62D 55/116; B62D 55/12

(57) ABSTRACT

A crawler pipeline detector, wherein includes a main body, a detection module and two crawler assemblies arranged on both sides of the body, the main body has a front end and the a rear end opposite the front end, the detection module is installed on the main body, each crawler assembly includes a drive wheel, a driven wheel and a crawler track, and the crawler track is mounted on the drive wheel, the drive wheel of one crawler assembly is close to the front end of the main body, and the drive wheel of the other crawler assembly is close to the rear end of the main body, so as to arrange on both sides of the main body; so that the two drive wheels of the two crawler assemblies are diagonally arranged on the main body to build a structural form for thereby ensuring the stable steering of the crawler pipeline detector.

### FIELD OF THE INVENTION

The invention related to the pipeline inspection technology field, in particular to a crawler pipeline detector.

### BACKGROUND OF THE INVENTION

Compared with traditional transportation methods, such as land, waterway, and air transportation, pipeline transportation has significant advantages in the transportation of certain specific items, such as the transportation of oil, water, and natural gas. Pipeline transportation not only has advantages of large quantities, continuous, rapid, small construction area and low transportation cost. Therefore, with the rapid development of cities, more and more pipelines are being laid. But it is obvious that the pipelines will inevitably suffer from aging, corrosion, or internal scaling after they are put into operation. These bad conditions will not only affect the normal operation of the pipelines, but even lead to irreversible safety accidents, such as natural gas leakage accidents, etc. Therefore, regular maintenance and repair of pipelines is one of the essential tasks.

Traditionally, pipeline maintenance and repair are completed manually. Professional inspection workers can promptly find out problems in pipelines and eliminate various safety hazards through daily inspections of pipelines to maintain the normal operation of pipelines and avoid safety accidents occur. As we all know, it is very effective to maintain and repair pipelines through professional inspection workers. However, as time goes, the laid pipelines has increased significantly. If just use professional inspection workers to maintain and repair all pipelines, the labor costs may be far exceeding the economic benefits of pipeline operation. Moreover, the maintenance and repair work of pipelines is professional and complex. The experience of inspection workers will also affect being able to timely discover pipeline faults. Therefore, the training of professional talents is also particularly important. However, the training of professional talents requires experience accumulation which made it difficult for the training of professional talents to keep up with the growth of pipelines in a timely manner, so that the current number of professional talents in the industry is insufficient. Due to a shortage of personnel, it is difficult to ensure the safety inspection of all pipelines.

With the development of industrial technology, many people think of using machinery to make up for the shortcomings of manual maintenance and repair of pipelines. Therefore, in the existing technology, many technical solutions for pipeline inspection have been proposed. Currently, the more feasible one is the pipeline robot, which can move in the pipeline and use its own detection equipment to detect the conditions inside the pipeline to discover the internal conditions of the pipeline and structural damage, etc., to achieve inspection purposes. The conditions in pipelines are complex and changeable, so for pipeline robots, having reliable travel capabilities is the key to successfully completing pipeline inspections. At present, the moving mechanisms of many pipeline robots are wheeled. The wheeled moving mechanism has a simple structure and is easy to design, and is more flexible and can handle the road, such as turning. However, the wheeled moving mechanism is only suitable for use on flat surfaces. When traveling on the road with complex conditions, the wheeled moving mechanism is prone to embarrassing situations such as traps. So, it is conceivable that the conditions inside the pipeline are unpredictable and can't guarantee flat surface inside of the pipeline. This is why the wheeled moving mechanism is limited to apply to the pipeline robots. So that, the pipeline robots with bionic structures also used in the prior art, that is, robots that use feet to move like humans or insects, and are available in various forms such as bipedal and four-legged. This type of pipeline robot only requires a relatively small contact with the ground to make movement. It is particularly adaptable to various road conditions. However, the movement of the bionic pipeline robot depends on the mutual cooperation of its legs. It is very difficult to reasonably arrange the legs of the robot ant the relevant program is not well developed. When one of the robot's legs is obstructed, such as being trapped by an obstacle, the robot cannot continue to move or even overturn. At the same time, even with the development of programing technology in the future, due to the special and complex structure, the cost of the bionic pipeline robot is difficult to reduce.

Since wheeled pipeline robots and bionic pipeline robots are difficult to be widely used, there are crawler pipeline robots on the market, which have better pass ability than wheeled pipeline robots and can flexibly climb over obstacles. At the same time, their technology is mature and reliable, and their cost is low. It is controllable and has significant advantages over wheeled pipeline robots and bionic pipeline robots with broad development prospects. However, as the current pipeline design becomes more and more complex, a pipeline system may have many turns, tees, etc., so the pipeline robot needs to make turns frequently while performing inspections, and it is very friendly for the crawler pipeline robot. The steering operation of the crawler pipeline robot is completed by the differential speed of the left and right crawlers. Therefore, the turning radius of the crawler pipeline robot is large to make it difficult to operate flexibly, and it is also prone to unstable situations such as sliding when turning. In order to ensure turning stability, existing crawler pipeline robots are generally designed to be relatively large and difficult to adapt to small spaces, making it difficult for existing crawler pipeline robots to be widely used.

### SUMMARY OF THE INVENTION

The present invention provides a crawler pipeline detector, which has flexible maneuverability and can adapt to travel on a driving path with many twists and turns to complete the detection work in the pipeline.

The present invention provides a crawler pipeline detector, which has balanced steering performance, that is, has good balance during steering, and the steering center is stable, suitable for completing steering in narrow pipelines, and has reliable practicality.

The present invention provides a crawler pipeline detector, which is compact structure and small for running in small pipelines and meets the detection needs of small pipelines.

The present invention provides a crawler pipeline detector, which can reduce the probability of rollover and can continue to travel while rollover, has reliable passing performance to avoid being trapped in the pipeline. Therefore, the crawler pipeline detector is reliable to complete pipeline inspection job.

The present invention provides a crawler pipeline detector, which can form a triangular stable contact with the pipeline to travel stably and is with reliable driving stability to ensure the smooth completion of the pipeline inspection job.

The present invention provides a crawler pipeline detector, which can protect the detection module to prevent it from being bumped and ensure the safety of the equipment and the smooth progress of the detection job.

The present invention provides a crawler pipeline detector, which includes a main body and two crawler assemblies arranged on both sides of the main body, wherein the crawler assemblies can drive the main body to move and make movement of the crawler pipeline detector. The two crawler assemblies using such structural design of the main body can ensure the stability of the crawler pipeline detector during travel, especially during the turning process, thereby ensuring the normal operation of the crawler pipeline detector.

The present invention provides a crawler pipeline detector, wherein the main body has a front end and a rear end. Each of the said crawler track assemblies includes a drive wheel, a driven wheel and a crawler track which is mounted between the drive wheel and the driven wheel, and the two crawler track assemblies are provided that the drive wheel of one crawler assembly is close to the front end of the main body, and the drive wheel of the other crawler assembly is close to the rear end of the main body, so as to arrange on both sides of the main body; so that the two drive wheels of the two crawler assemblies are diagonally arranged on the main body to build a structural form. Therefore, during the steering process of the crawler pipeline detector, the power provided by the two driving wheels can ensure the stability of the crawler pipeline detector in a balanced manner, stabilize the steering center of the crawler-type pipeline detector, so that the crawler pipeline detector can successfully complete the steering.

The present invention provides a crawler pipeline detector, wherein the two drive wheels of two crawler assemblies are arranged on both sides of the body in a diagonal direction, so that during the turning process, the power provided by the two drive wheels can improve the maneuverability of the crawler pipeline detector. And the crawler-type pipeline detector can flexibly complete the steering, so as it can adapt to work in pipelines with many twists and turns.

The present invention provides a crawler pipeline detector, wherein the two drive wheels of the two crawler assemblies are arranged on both sides of the body in a diagonal direction to optimizes the arrangement of the motor in the main body which drives the two driving wheels to rotate, so that the structure of the body is more compact designed to the minimize the crawler pipeline detector and meets the needs test needs in small pipelines.

The present invention provides a crawler pipeline detector, wherein the crawler pipeline detector comprises a power assembly, the power assembly includes two drive motors and the two drive motors drive the two drive wheels to rotate and that output the power to the said crawler assemblies. The two drive motor is set inside the main body and the two drive wheels are arranged on the main body in a diagonal direction. So, one of the dive motors is close to the front end and the other drive motor is close to the rear end which are set inside the main body. This can avoid two drive motor being arranged parallelly on the main body. So as to minimize the volume of the main body and compact the structure of the crawler pipeline detector to achieve miniaturization of the crawler pipeline detector.

The present invention provides a crawler pipeline detector, wherein includes a detection module, the detection module is installed on the main body to detect pipelines and meet the detection requirements for pipelines. The detection module can fully detect pipelines to ensure the detection accuracy of the crawler pipeline detector.

The present invention provides a crawler pipeline detector, wherein includes a chassis, the detection module is installed on the chassis, and the chassis is installed on the main body. The height of the chassis can be adjusted to change the height of the detection module according to the lifting and lowering of the chassis, so as to be suitable for detecting different height positions inside the pipeline. And based on the lifting and lowering of the chassis, the crawler pipeline detector can adjust the overall height to adapt to pipes of different sizes and improves the practicality of the crawler pipeline detector.

The present invention provides a crawler pipeline detector, wherein includes an auxiliary wheel and it is installed on the chassis. When the crawler pipeline detector is moving in the pipeline, the chassis is raised so that the auxiliary wheels are in contact with the pipeline, then the auxiliary wheels and the two crawler assemblies together form a joint with the pipeline into a stable triangular contact to ensure the stability of the crawler pipeline detector while travels in the pipeline.

The present invention provides a crawler pipeline detector, wherein the auxiliary wheels and the two crawler assemblies together form a stable triangular contact with the pipeline to form a stable triangular structure in the pipeline for reducing the probability of rollover of the crawler pipeline detector. Based on the auxiliary wheels contacting with the pipeline, when the crawler pipeline detector overturns, the auxiliary wheels and the two crawler assemblies can contact with the pipeline to keep traveling with reliable pass ability, and avoid the crawler pipeline detector being trapped in the pipeline. So, the crawler pipeline detector can reliably complete the detection of the pipeline.

The present invention provides a crawler pipeline detector, wherein the auxiliary wheels are in contact with the pipeline. The auxiliary wheels can buffer the bumps in the height direction of the crawler pipeline detector during travelling. By keeping the highest point of the crawler pipeline detector at the auxiliary wheels, it can prevent the detection module from being bumped, thereby extending the service life of the crawler pipeline detector.

The present invention provides a crawler pipeline detector, wherein the crawler assemblies improve the pass ability of the crawler pipeline detector, and the auxiliary wheels buffer the crawler pipeline detector from bumps. So, the crawler pipeline detector can stably travel under bumpy road conditions and improve the adaptability of the crawler pipeline detector to various complex road conditions.

The present invention provides a crawler pipeline detector, wherein the chassis includes a base, a mounting rod and a scissor rack arranged between the base and the mounting rod, the base of the chassis is installed on the chassis, and the detection module is installed on the mounting rod, the scissor rack includes a first cross arm and a second cross arm, the first cross arm and the second cross arm pivotally cross each other, the base sets a base guide rail, the mounting rod sets a mounting rod guide rail, the first cross arm provides a first fixed end and a first movable end, and the second cross arm provides a second fixed end and a second movable end, the first cross arm is pivotably fixed to the base by the first fixed end, the first movable end of the first cross arm is movably retained in the mounting rod guide rail, the second cross arm is pivotably fixed to the mounting rod by the second fixed end, the second movable end of the second cross arm is movably retained in the base guide rail, the angle change between the first cross arm and the second cross arm forms the lifting and lowering of the chassis. During the lifting and lowering of the chassis, the first movable end of the first cross arm is guided by the mounting rod guide rail and moves along the mounting rod guide rail, and the second movable end of the second cross arm is guided by the base guide rail and moves along the base guide rail, thus ensuring the lifting stability of the chassis.

The present invention provides a crawler pipeline detector, wherein the detection module includes a mounting part and a detector, wherein the mounting part is installed on the chassis and provides a rotating axis which parallels to the height direction of the crawler pipeline detector, and the detector is rotatably mounted on the mounting part through a rotating shaft. Therefore, the direction of the detector can be changed by the rotation of the detector on the mounting part. So, the pipeline detection range of the detector is wider which ensure comprehensive detection of the pipeline by the crawler pipeline detector.

The present invention provides a crawler pipeline detector, wherein the mounting part includes a mounting head and a mounting groove, the mounting head is mounted on the end of the mounting rod and provides a mounting shaft which perpendiculars to the rotating shaft, and the bottom of the mounting groove is fixed with the mounting shaft to rotatably be mounted on the mounting head, the rotating shaft is disposed in the mounting groove, and the detector is mounted in the mounting groove through the rotating shaft, thereby to build a structural form which the detector is rotatably mounted in the mounting part. Therefore, basing on the lifting and lowering of the chassis, and/or the rotation of the mounting groove relating to the mounting head, and/or the direction change of the detector relating to the rotation relating to the mounting groove, the comprehensive detection of the pipeline by the crawler pipeline detector is ensured and the detection accuracy and reliability of detection results of the crawler pipeline detector is improved.

The present invention provides a crawler pipeline detector, wherein the detector is an infrared thermal imaging camera, which is used to detect pipelines through infrared thermal imaging technology. It is conducive to adapt to detection job in dark and low-visibility environments, adapt to the environment inside the pipeline and be able to ensure the accuracy of detection running in pipelines.

The present invention provides a crawler pipeline detector, wherein the direction from the rear end to the front end is the forward direction of the crawler pipeline detector, the detection module is installed on the end of the mounting rod which faces the forward direction of the crawler pipeline detector. Therefore, the crawler pipeline detector can inspect the undetected pipeline to discover problems ahead in time and keep operation safety of the crawler pipeline detector.

The present invention provides a crawler pipeline detector, wherein includes a data interface, the data interface is communicatively connected to the detection module to export the detection data of the detection module while the date line is connected. The data interface is preferably set on the base which is located close to the rear and is orientated opposite to the forward direction of the crawler pipeline detector, so as to facilitate connecting the corresponding data line when the crawler pipeline detector is running and avoid the corresponding data line entangling or blocking the travel of the crawler pipeline detector.

The present invention provides a crawler pipeline detector, wherein the data interface and the detection module are connected by line to ensure the reliability of data exchange in various environments and ensure the detection data of the detection module being accurately transmitted. The crawler pipeline detector further includes at least one line lead ring for guiding the routing of corresponding data line, thereby ensuring the appearance of the crawler pipeline detector and preventing the corresponding data lines from being entangled with other objects.

According to one aspect of the invention, the present invention provides a crawler-type pipeline detector, the crawler pipeline detector, comprising:
a main body, wherein the main body has a front end and a rear end opposite to the front end;
a detection module, wherein the detection module is installed on the main body; and
two crawler track assemblies, wherein each crawler track assembly includes a drive wheel, a driven wheel and a crawler track, the crawler track is mounted between the drive wheel and the driven wheel, and the two crawler track assemblies are respectively provided on each side of the main body, the drive wheel of one crawler assembly is close to the front end of the main body, and the drive wheel of the other crawler assembly is close to the rear end of the main body, so as to arrange on both sides of the main body; so that the two drive wheels of the two crawler assemblies are diagonally arranged on the main body to build a structural form for thereby ensuring the stable steering of the crawler pipeline detector.

In an embodiment of the invention, the crawler pipeline detector comprises a chassis and an auxiliary wheel, the chassis is installed on the main body to set up the detection module, and the auxiliary wheel is installed on the chassis to form a stable triangular structure with the two crawler assemblies in the corresponding pipeline.

In an embodiment of the invention, the crawler pipeline detector comprises a power assembly, the power assembly includes two drive motors and the two drive motors drive the two drive wheels to rotate, one of the two drive motors is arranged close to the front end, and the other drive motor is arranged close to the rear end of in the main body.

In an embodiment of the invention, the chassis includes a base, a mounting rod and a scissor rack arranged between the base and the mounting rod, the base of the chassis is installed on the main body, and the detection module is installed on the mounting rod, the scissor rack includes a first cross arm and a second cross arm, the first cross arm and the second cross arm pivotally cross each other, the two ends of the first cross arm and the second cross arm are connected to the base and the mounting rod respectively, so that by adjusting the angle between the first cross arm and the second cross arm to change the distant between the base and the mounting rod, and then to adjust the height of the crawler pipeline detector.

In an embodiment of the invention, the base provides a base guide rail, the mounting rod provides a mounting rod guide rail, the first cross arm provides a first fixed end and a first movable end, and the second cross arm provides a second fixed end and a second movable end, the first cross arm is pivotably fixed to the base by the first fixed end, and the first movable end is movably retained in the mounting rod guide rail and is connected to the base and the mounting rod, the second cross arm is pivotably fixed to the mounting rod with the second fixed end, and the second movable end is movably retained in the base guide rain and is connected to the base and the mounting rod.

In an embodiment of the invention, the detection module includes a mounting part and a detector, wherein the mounting part is installed on the chassis and provides a rotating axis which parallels to the height direction of the crawler pipeline detector, and the detector is rotatably mounted on the mounting part through a rotating shaft.

In an embodiment of the invention, the mounting part includes a mounting head and a mounting groove, the mounting head is mounted on the end of the mounting rod and provides a mounting shaft which perpendiculars to the rotating shaft, and the bottom of the mounting groove is fixed with the mounting shaft to rotatably be mounted on the mounting head, the rotating shaft is disposed in the mounting groove, and the detector is mounted in the mounting groove through the rotating shaft, thereby to build a structural form which the detector is rotatably mounted in the mounting part.

In an embodiment of the invention, the direction from the rear end to the front end is the forward direction of the crawler pipeline detector, the detection module is installed on the end of the mounting rod which faces the forward direction of the crawler pipeline detector.

In an embodiment of the invention, the crawler pipeline detector includes a data interface, the data interface is communicatively connected to the detection module, and the data interface is used to be accessed by a corresponding data line to derive detection data of the detection module, the data interface is disposed on the base closing to the rear end and set an orientation opposite to the forward direction of the crawler pipeline detector.

In an embodiment of the invention, the data interface and the detection module are connected through wired communication, the crawler pipeline detector further includes at least one wire leading ring for guiding the corresponding data line.

Further purpose and advantages of the present invention will be fully realized by understanding the following description and drawings.

### BRIEF DESCRIPTION OF THE DRAWINGS

FIG. 1 is a schematic three-dimensional structural diagram of the crawler pipeline detector according to an embodiment of the present invention.

FIG. 2 is a schematic top view of the structure of the crawler pipeline detector according to the above-mentioned embodiment of the present invention.

FIG. 3 is a schematic diagram of the disassembled structure of the crawler pipeline detector according to the above-mentioned embodiment of the present invention.

FIG. 4 is a partial structural diagram of the crawler pipeline detector according to the above-mentioned embodiment of the present invention.

FIG. 5 is a partial structural diagram of the crawler pipeline detector according to the above-mentioned embodiment of the present invention.

FIG. 6 is a schematic diagram of the operation of the crawler pipeline detector in a corresponding pipeline according to the above embodiment of the present invention.

FIG. 7 is a schematic diagram of the crawler pipeline detector traveling upside down in the corresponding pipeline according to the above embodiment of the present invention.

### DESCRIPTION OF THE EMBODIMENTS

The following description is provided to disclose the invention to enable those skilled in the art to practice the invention. The preferred embodiments in the following description are only examples, and other obvious modifications may occur to those skilled in the art. The basic principles of the invention defined in the following description may be applied to other embodiments, variations, improvements, equivalents and other technical solutions without departing from the spirit and scope of the invention.

Those skilled in the art will understand that in the disclosure of the present invention, the terms “vertical”, “horizontal”, “upper”, “lower”, “front”, “back”, “left”, “right”, “vertical”, “horizontal”, “top”, “bottom”, “inner”, “outer”, etc. indicates the orientations or positional relationships indicated which are based on the orientations or positional relationships shown in the drawings and are only for the convenience of describing this document. The invention and simplified description are not intended to indicate or imply that the device or element referred to must have a specific orientation, be constructed and operate in a specific orientation, and therefore the above terms are not to be construed as limitations of the present invention.

It should be understood that the term “a” should be understood as “at least one” or “one or more”, that is, in one embodiment, the number of an element may be one, while in other embodiments, the number of the element may be multiple, and the term “one” shall not be understood as a limitation on the number.

In the description of the present invention, it should be noted that, unless otherwise clearly stated and limited, the terms “install”, “connect with” and “connect to” should be understood in a broad sense. For example, it can be a fixed connection or a detachable connection. Connection, or integral connection; it can be mechanical connection, electrical connection or mutual communication; it can be direct connection, or indirect connection through an intermediary, it can be internal connection of two elements or interaction of two elements relation. For those of ordinary skill in the art, the specific meanings of the above terms in the present invention can be understood according to specific circumstances.

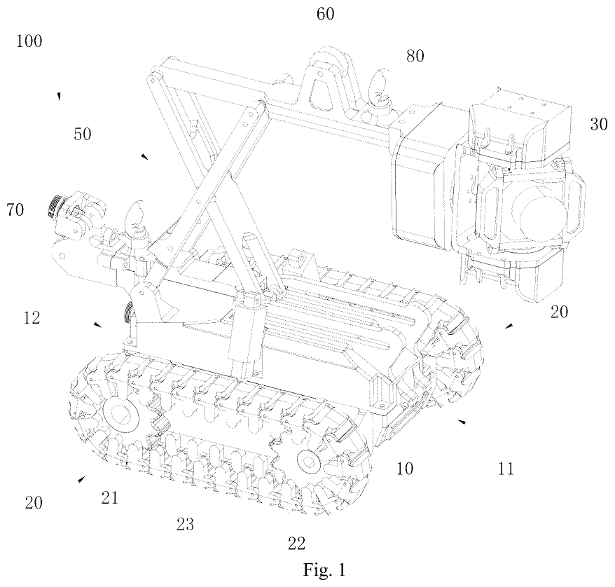

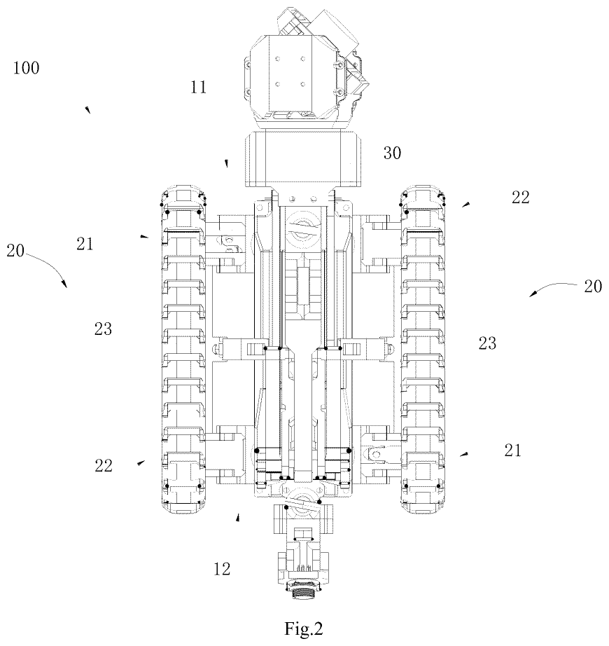

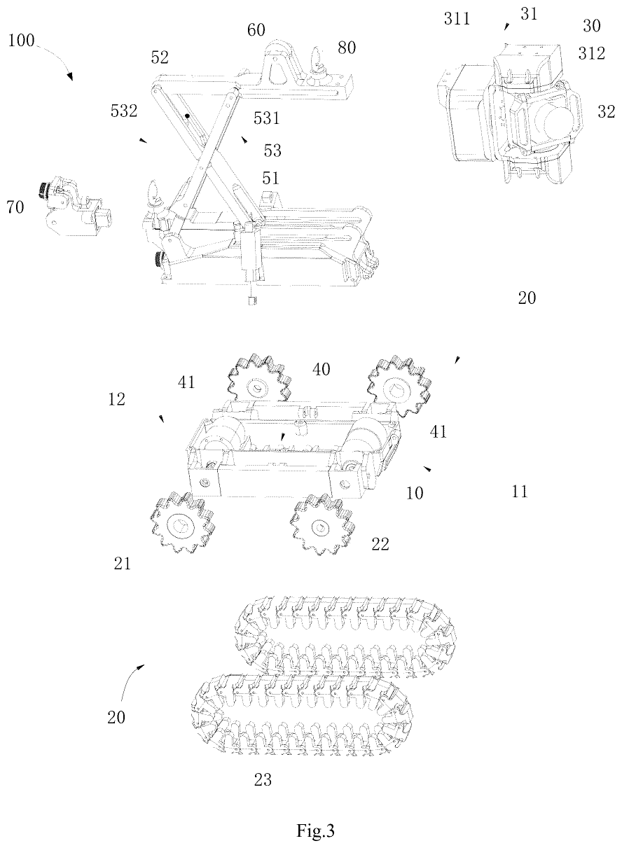

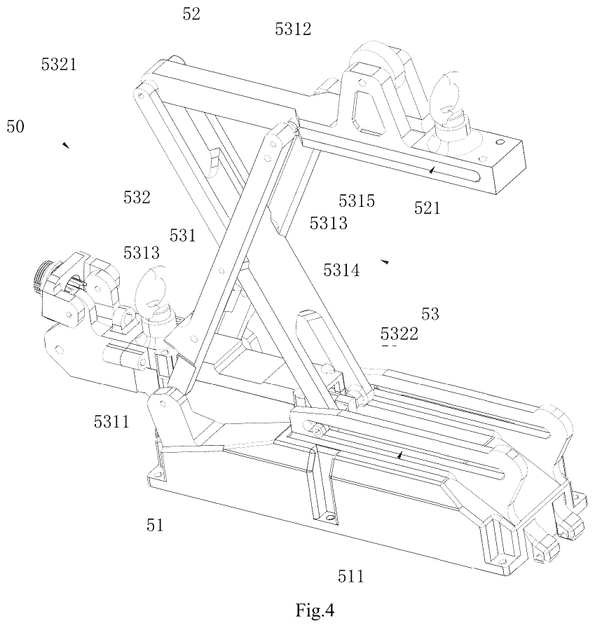

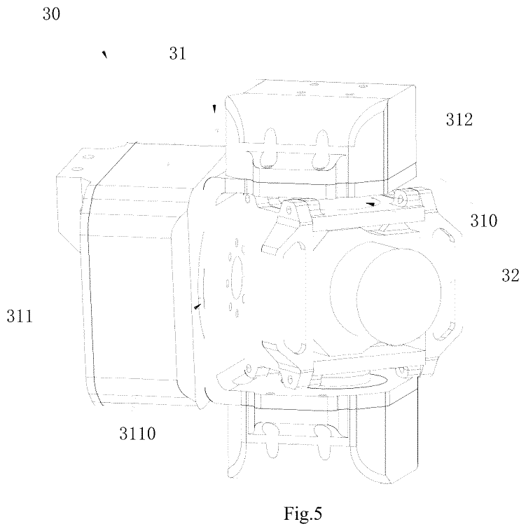

Referring to FIGS. 1 to 7 of the drawings of the present invention, a crawler pipeline detector 100 according to an embodiment of the present invention is schematically illustrated, wherein the crawler pipeline detector 100 includes a main body 10 and two crawler assemblies 20 and a detection module 30. Two crawler assemblies 20 are disposed on opposite sides of the main body 10 to drive the main body 10 to move, thereby realizing the movement of the crawler pipeline detector 100. The detection module 30 is installed on the main body 10 to inspect the pipeline by following movement of the main body 10 in the corresponding pipeline. The crawler pipeline detector 100 has flexible maneuverability and reliable pass ability, and can be used in complex road conditions to adapt to the inspection needs of different pipelines.

Specifically, each crawler assembly 20 includes a drive wheel 21, a driven wheel 22 and a crawler track 23. The crawler track 23 is mounted between the driving wheel 21, and is supported by the drive wheel 21 and the driven wheel 22. In particular, the structural design of the two crawler track assemblies 20 being set on the body 10 can enable the crawler pipeline detector 100 to ensure the stability during the traveling process, especially during the turning process, thereby ensuring the normal operation of the crawler pipeline detector 100.

In detail, the main body 10 has a front end 11 and a rear end 12 opposite to the front end 11. The two crawler assemblies 20 have the drive wheel 21 of one of the crawler assemblies 20 close to the front end 11. The drive wheel 21 of the other crawler assembly 20 is disposed on both sides of the main body 10 close to the rear end 12, so as to form two drive wheels 21 of the two crawler assemblies 20 are disposed diagonally of the main body 10. So that during the turning process of the crawler pipeline detector 10, the power provided by the two drive wheels 21 can ensure the stability of the crawler pipeline detector 100 in a balanced manner, stabilize the steering center of the crawler pipeline detector 100, so that the crawler pipeline detector 100 can successfully complete the steering.

It is worth mentioning that, the two crawler track assemblies 20 are provided that the drive wheel 21 of one crawler assembly 20 is close to the front end 11, and the drive wheel 21 of the other crawler assembly 20 is close to the rear end 2. That makes the two drive wheels 21 diagonally arrange on the both side of the main body. Therefore, during the steering process of the crawler pipeline detector 100, the power provided by the two driving wheels 21 can improve the maneuverability of the crawler pipeline detector 100, so that the crawler-type pipeline detector 100 can be maneuvered flexibly. The steering is completed so that the crawler pipeline detector 100 can adapt to travel on a multi-curved driving path and flexibly complete the pipeline detection job in the corresponding pipeline.

It is also worth mentioning that, because the two drive wheels 21 of the two crawler assemblies 20 are disposed diagonally on the main body 10, the arrangement of the motors used to drive the two drive wheels 21 to rotate within the main body 10 can be optimized. This allows the structure of the main body 10 to be designed to be more compact, which is conducive to the miniaturization of the crawle pipeline detector 100 and meets the detection requirements for small pipelines.

Specifically, the crawler pipeline detector 100 includes a power assembly 40. The power assembly 40 includes two drive motors 41, and the two driving motors 41 are used to drive the two drive wheels 21 to rotate, so as to drive the crawler assembly 20. The two drive motors 41 being housed in the main body, and due to the structure of the two drive wheels 21 being diagonally arranged on the main body 10, the two drive motors 41 of the power assembly 40 can be accommodated in the main body 10 where one drive motor 41 is close to the front end 11 and the other drive motor 41 is close to the rear end 12 to avoid two drive motor 41 is laterally accommodated side by side in the main body 10, which is beneficial to reducing the volume of the body 10, making the structure of the crawler pipeline detector 100 more compact, and is beneficial to realizing miniaturization of the crawler pipeline detector 100.

Further, the crawler pipeline detector 10 includes a chassis 50. The chassis 50 is installed on the main body 10, and the detection module 30 is installed on the chassis 50 where is erected on the main body 10 by the chassis 50. Preferably, in this embodiment of the present invention, the height of the chassis 50 can be adjusted, thereby changing the height of the detection module 30 by lifting and lowering of the chassis 50, so as to be adapted to detect different height positions inside the pipeline, and to adapt to different sizes pipeline by lifting an lowering the chassis 50 to adjust the overall height of the crawler pipeline detector 100, so as improving the practicality of the crawler pipeline detector 100.

Specifically, the chassis 50 includes a base 51, a mounting rod 52 and a scissor rack 53 arranged between the base 51 and the mounting rod 52, the base 50 of the chassis 51 is installed on the main body 10, and the detection module 30 is installed on the mounting rod 52, the scissor rack 53 includes a first cross arm 531 and a second cross arm 532, the first cross arm 531 and the second cross arm 532 pivotally cross each other, the two ends of the first cross arm 531 and the second cross arm 532 are connected to the base 51 and the mounting rod 52 respectively, so that by adjusting the angle between the first cross arm 531 and the second cross arm 532 to change the distant between the base 51 and the mounting rod 52, and then to adjust the height of the crawler pipeline detector 100.

It is worth mentioning that, the chassis 50 ensures stability during the lifting process due to the first cross arm 531 and the second cross arm 532 intersected with each other. More preferably, in order to further ensure the lifting stability of the chassis 50, the present invention further guides the movement of the first cross arm 531 and the second cross arm 532 to further optimize the performance of the chassis 50.

In detail, the base 51 provides a base guide rail 511, the mounting rod 52 provides a mounting rod guide rail 521, the first cross arm 531 provides a first fixed end 5311 and a first movable end 5312, and the second cross arm 532 provides a second fixed end 5321 and a second movable end 5322, the first cross arm 531 is pivotably fixed to the base 51 by the first fixed end 5311. And the first movable end 5312 of the first cross arm 531 is movably retained on the mounting rod guide rail 521. And the second movable end 5322 of the second cross arm 532 is movably retained on the base guide rail 511. So, when the angle between the first cross arm 531 and the second cross arm 532 changes, that is, during the lifting and lowering of the chassis 50, the first movable end 5312 of the first cross arm 531 is guided by the mounting rod guide rail 521 and moves on the mounting rod guide rail 521. The second movable end 5322 of the second cross arm 532 is guided by the base guide rail 511 and moves in the base guide rail 511. Thereby, the mounting rod guide rail 521 guides the movement of the first cross arm 531 and The base guide rail 511 guides the movement of the second cross arm 532 to ensure the lifting stability of the chassis 50.

Particularly, in this embodiment of the present invention, the second cross arm 532 is clamped by the first cross arm 531, thereby ensuring the intersection structural stability of the first cross arm 531 and the second cross arm 532. More specifically, the first cross arm 531 includes two longitudinal rods 533 and a transverse rod 534 connecting the two longitudinal rods 533. The two longitudinal rods 533 are arranged in parallel and the second cross arm 532 is disposed between the two longitudinal rods 533 and is clamped by the two longitudinal rods 533. Thus, the structural stability of the first cross arm 531 and the second cross arm 532 is ensured. A pair of two ends in the same direction of the two longitudinal rods 533 are pivotably fixed to the base 51 and the first fixed end 5311 of the first cross arm 531 is pivotably fixed to the base 51. The other pair of two ends in the same direction of the two longitudinal rods 533 are connected by a sliding rod 5315, and the sliding rod 5315 is retained on the mounting rod guide rail 521 and the first movable end 5312 of the first cross arm 531 is movably retained on the mounting rod guide rail 521.

It can be understood that, equivalently, in some embodiments of the present invention, the first cross arm 531 is clamped by the second cross arm 532, the implementation effect is equivalent to the second cross arm 532 being clamped by the first cross arm 531 clamps.

Particularly, in this embodiment of the present invention, the chassis 50 is detachably installed on the main body 10, to facilitate the maintenance and parts replacement of the crawler pipeline detector 30 by disassembling the chassis 50. Those skilled in the art can understand that in some embodiments, the chassis 50 can be non-detachably connected to the body 10, which is not limited by the present invention.

It is worth mentioning that, the detection module 30 can flexibly rotate so as to comprehensively inspect the pipeline and ensure the detection accuracy of the crawler pipeline detector 100. Specifically, the detection module 30 includes a mounting part 31 and a detector 32. The mounting part 31 is installed on the chassis 50 and has a rotating axis 310 parallel to the height direction of the crawler pipeline detector 100. The detector 32 is rotatably mounted on the mounting part 31 through the rotating shaft 310, so that the direction of the detector 32 can be changed by the rotation of the detector 32 on the mounting part 31. The detection range of the pipeline by the detector head 32 is wider to ensure the comprehensive detection of the pipeline by the crawler pipeline detector 100.

Further, the mounting part 31 includes a mounting head 311 and a mounting groove 312, the mounting head 311 is mounted on the end of the mounting rod 52 and provides a mounting shaft 3110 which perpendiculars to the rotating shaft 310, and the bottom of the mounting groove 312 is fixed with the mounting shaft 3110 to rotatably be mounted on the mounting head 311, the rotating shaft 310 is disposed in the mounting groove 312, and the detector 32 is mounted in the mounting groove 312 through the rotating shaft 310, thereby to build a structural form which the detector 32 is rotatably mounted in the mounting part 31. By this way, based on the lifting and lowering of the frame 50, and/or the rotation of the mounting groove 312 relative to the mounting head 311, and/or the rotation of the detector 32 relative to the mounting groove 312, the detector 311 change the direction, thereby ensuring the comprehensive inspection of pipelines by the crawler pipeline detector 100, and improving the detection accuracy and reliability of detection results of the crawler pipeline detector 100.

Preferably, the detection module 30 is disposed toward the forward direction of the crawler pipeline detector 100. Specifically, the direction from the rear end 12 to the front end 11 is the forward direction of the crawler pipeline detector 100. The detection module 30 is installed on the end of the mounting rod 52 facing the forward direction of the crawler pipeline detector 10, so that the detection module 30 detects toward the forward direction of the crawler pipeline detector 100. Thereby, the pipelines that the crawler pipeline detector 100 has not been passed through can be detected and problems ahead can be discovered in time to ensure the operation safety of the crawler pipeline detector 100.

It is worth mentioning that, in this embodiment of the present invention, the detector 32 is implemented as an infrared thermal imaging camera and detect the pipeline through infrared thermal imaging technology which is beneficial to adapting to the situation in the dark. Compared with the current method of detecting pipelines using CCTV video surveillance, the detection job is carried out in an environment with dark and low visibility, thus ensuring the accuracy of pipeline detection.

It is also worth mentioning that, in this embodiment of the present invention, the detection module 30 is detachably installed on the chassis 50, so that the type of the detection module 30 can be replaced according to actual usage conditions, or to facilitate maintenance and repair of the detection module 30, etc. And in some embodiments, the detection module 30 is non-detachably installed on the chassis 50 to enhance integrity of the crawler pipeline detector 100, the present invention does not limit this.

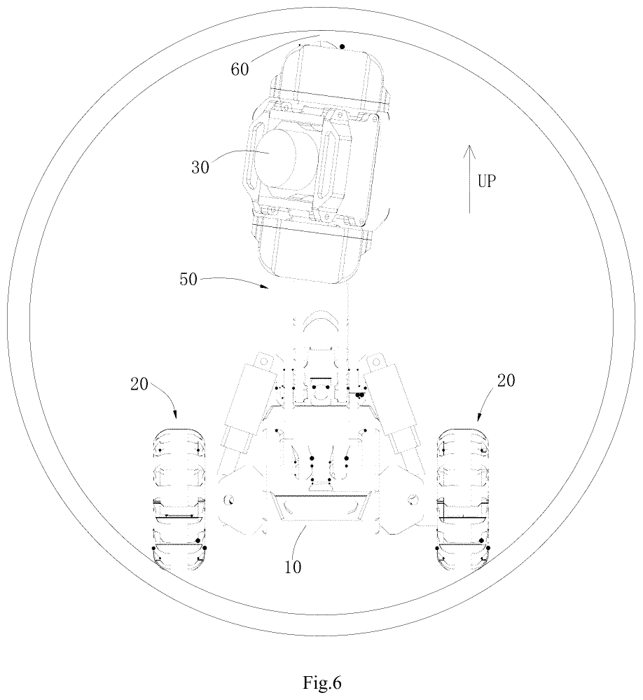

In particular, the crawler pipeline detector 100 can form a triangular stable contact with the pipeline and stably travel in the pipeline which can drive reliable stably to ensure the completion of smooth pipeline inspection. Specifically, the crawler pipeline detector 100 includes an auxiliary wheel 60. The auxiliary wheel 60 is disposed on the chassis 50, and the highest point of the crawler pipeline detector 100 is located at the auxiliary wheels 60, detail refer to FIG. 6. When the crawler pipeline detector 100 is traveling in the pipeline, the chassis 50 is raised to make the auxiliary wheels 60 abut against the pipeline. The auxiliary wheel 60 and the two crawler assemblies 20 together form a stable triangular contact with the pipeline to ensure the stability of the crawler pipeline detector 100 in the pipeline.

In other words, the crawler pipeline detector 100 uses the two crawler assemblies 20 and the auxiliary wheels 60 to form a triangular structure that abuts the inner wall of the pipeline, thereby maintaining the stability of the crawler pipeline detector 100 in the pipeline. Especially in circular pipelines, the crawler pipeline detector 100 forms a stable triangular force-bearing structure within the diameter of the circular pipeline, which can greatly reduce the probability of rollover of the crawler pipeline detector 100.

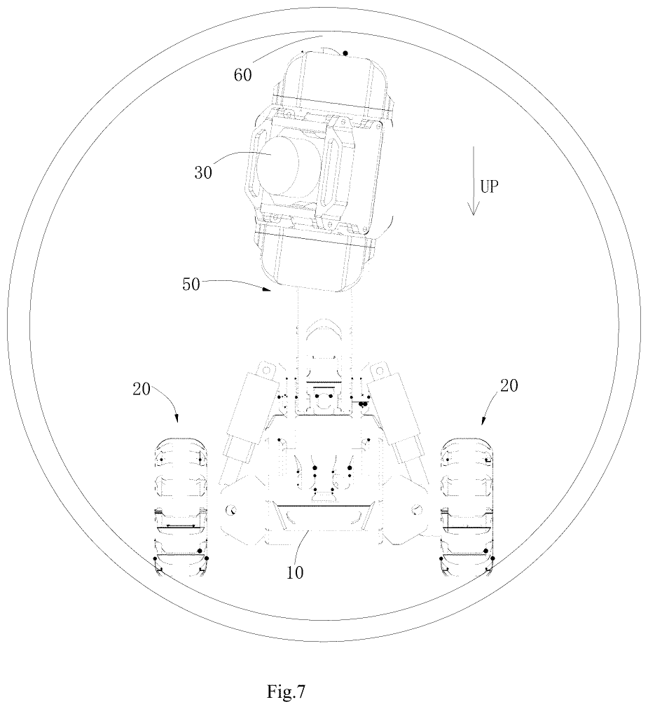

And referring to FIG. 7, even though the crawler pipeline detector 100 rolls over during operation, due to the auxiliary wheel 60 is in contact with the pipeline, the auxiliary wheel 60 and the two crawler assemblies 20 are in contact with the pipeline, that is, it can continue to travel without being limited by angle deviations and has reliable pass ability, thereby avoiding the embarrassing situation of the crawler pipeline detector 100 being trapped in the pipeline. So, the crawler-type pipeline detector 100 can reliably complete the inspection of the pipeline.

It is worth mentioning that, because the auxiliary wheels are in contact with the pipeline, the auxiliary wheels can buffer the bumps in the height direction of the crawler pipeline detector during travelling. And due to the highest point at high direction of the crawler pipeline detector 100 is located at the auxiliary wheel 60, the height of the detection module 30 is lower than the auxiliary wheel 60, thereby preventing the detection module 30 from hitting the pipeline, and extending the service life of the crawler pipeline detector 100.

In addition, the auxiliary wheel 60 is in contact with the pipeline to forms a stable triangular structure with the two crawler assemblies 20 in the pipeline, so the auxiliary wheel 60 can buffer the impact of the crawler pipeline detector 100 during operation. And based on the characteristics of the crawler assembly 20 to improve the pass ability of the crawler pipeline detector 100, the crawler pipeline detector 100 can travel stably under bumpy road condition and improve the crawler pipeline detector 100 being adaptable to various complex road conditions.

Further, the crawler pipeline detector 100 includes a data interface 70, wherein the data interface 70 is communicatively connected to the detection module 30. The corresponding data line can be pluggable connected to the data interface 70. The data interface 70 is configured to export the detection data of the detection module 30 when is accessed by the corresponding data line, thereby transmitting the detection data to the corresponding terminal device through the corresponding data line and the detection operator can notice the detection results of the pipeline by the crawler pipeline detector 100.

In particular, the data interface 70 is preferably disposed on the base 51 closing to the rear end 12 which has an orientation opposite to the forward direction of the crawler pipeline detector 100, so that the corresponding data lines will not conflict with the movement of the crawler pipeline detector 100 when the date line inserted into the data interface 70. And the corresponding data lines will not be entangled or blocking the progress of the crawler pipeline detector 100, thereby facilitating connection of the corresponding data line during the operating of the crawler pipeline detector 100 to transmit corresponding detection data in real time.

It is worth mentioning that, in order to ensure the reliability of the communication connection between the data interface 70 and the detection module 30, to avoid communication interrupt between the data interface 70 and the detection module 30 in harsh environments, the data interface 70 and the detection module 30 are connected through wired communication, that is, the data interface 70 and the detection module 30 are connected through data lines to ensure the reliability of data exchange in various environments and ensure the detection data of the detection module 30 can be accurately transmitted. Those skilled in the art should understand that in some embodiments, the data interface 70 and the detection module 30 may also be connected by wireless communication, such as Bluetooth.

In particular, for the purpose of convenient and standardized wiring, the crawler pipeline detector 100 further includes at least one wire lead ring 80 to guide the corresponding data line wiring, thereby standardizing the data lines to the surface of the crawler pipeline detector 100 and ensuring the appearance of the crawler pipeline detector 100 to prevent the corresponding data lines from being entangled with foreign objects.

That is, the crawler pipeline detector 100 has flexible maneuverability and compact structure, good pass ability, and strong adaptability to various pipelines. At the same time, the crawler pipeline detector 100 can be used in the corresponding pipelines to form stable triangular contact with the pipeline for ensuring the stability of the crawler pipeline detector 100 traveling in the pipeline. Therefore, the crawler pipeline detector 100 can be reliably used to inspect pipelines, and can be widely used and popularized.

Those skilled in the art should understand that the embodiments of the present invention shown in the above description and drawings are only examples and do not limit the present invention. The object of the present invention has been completely and effectively achieved. The functional and structural principles of the present invention have been shown and described in the embodiments, and the implementation of the present invention may have any variations or modifications without departing from the principles.

1. A crawler pipeline detector, comprising:
a main body, wherein the main body has a front end and a rear end opposite to the front end;
a detection module, wherein the detection module is installed on the main body; and
two crawler track assemblies, wherein each crawler track assembly includes a drive wheel, a driven wheel and a crawler track, the crawler track is mounted between the drive wheel and the driven wheel, and the two crawler track assemblies are respectively provided on each side of the main body, the drive wheel of one crawler assembly is close to the front end of the main body, and the drive wheel of the other crawler assembly is close to the rear end of the main body, so as to arrange on both sides of the main body; so that the two drive wheels of the two crawler assemblies are diagonally arranged on the main body to build a structural form for thereby ensuring the stable steering of the crawler pipeline detector.

2. The crawler pipeline detector of claim 1, wherein the crawler pipeline detector comprises a chassis and an auxiliary wheel, the chassis is installed on the main body to set up the detection module, and the auxiliary wheel is installed on the chassis to form a stable triangular structure with the two crawler assemblies in the corresponding pipeline.

3. The crawler pipeline detector of claim 2, wherein the crawler pipeline detector comprises a power assembly, the power assembly includes two drive motors and the two drive motors drive the two drive wheels to rotate, one of the two drive motors is arranged close to the front end, and the other drive motor is arranged close to the rear end of in the main body.

4. The crawler pipeline detector of claim 3, wherein the chassis includes a base, a mounting rod and a scissor rack arranged between the base and the mounting rod, the base of the chassis is installed on the main body, and the detection module is installed on the mounting rod, the scissor rack includes a first cross arm and a second cross arm, the first cross arm and the second cross arm pivotally cross each other, the two ends of the first cross arm and the second cross arm are connected to the base and the mounting rod respectively, so that by adjusting the angle between the first cross arm and the second cross arm to change the distant between the base and the mounting rod, and then to adjust the height of the crawler pipeline detector.

5. The crawler pipeline detector of claim 4, wherein the base provides a base guide rail, the mounting rod provides a mounting rod guide rail, the first cross arm provides a first fixed end and a first movable end, and the second cross arm provides a second fixed end and a second movable end, the first cross arm is pivotably fixed to the base by the first fixed end, and the first movable end is movably retained in the mounting rod guide rail and is connected to the base and the mounting rod, the second cross arm is pivotably fixed to the mounting rod by the second fixed end, and the second movable end is movably retained in the base guide rail and is connected to the base and the mounting rod.

6. The crawler pipeline detector of claim 4, wherein the detection module includes a mounting part and a detector, wherein the mounting part is installed on the chassis and provides a rotating axis which parallels to the height direction of the crawler pipeline detector, and the detector is rotatably mounted on the mounting part through a rotating shaft.

7. The crawler pipeline detector of claim 6, wherein the mounting part includes a mounting head and a mounting groove, the mounting head is mounted on the end of the mounting rod and provides a mounting shaft which perpendiculars to the rotating shaft, and the bottom of the mounting groove is fixed with the mounting shaft to rotatably be mounted on the mounting head, the rotating shaft is disposed in the mounting groove, and the detector is mounted in the mounting groove through the rotating shaft, thereby to build a structural form which the detector is rotatably mounted in the mounting part.

8. The crawler pipeline detector of claim 4, wherein the direction from the rear end to the front end is the forward direction of the crawler pipeline detector, the detection module is installed on the end of the mounting rod which faces the forward direction of the crawler pipeline detector.

9. The crawler pipeline detector of claim 4, wherein the crawler pipeline detector includes a data interface, the data interface is communicatively connected to the detection module, and the data interface is used to be accessed by a corresponding data line to derive detection data of the detection module, the data interface is disposed on the base closing to the rear end and set an orientation opposite to the forward direction of the crawler pipeline detector.

10. The crawler pipeline detector of claim 9, wherein the data interface and the detection module are connected through wired communication, the crawler pipeline detector further includes at least one line leading ring for guiding the corresponding data line.
